(19) United States
(12) Patent Application Publication
(10) Pub. No.: US 2024/0427370 A1
(43) Pub. Date: Dec. 26, 2024

(54) COMMUNICATION BETWEEN CIRCUITS WITH DIFFERENT CLOCK FREQUENCIES

(71) Applicant: Intel Corporation, Santa Clara, CA (US)

(72) Inventors: Gabriel Munguia, Phoenix, AZ (US); Peter Chambers, Phoenix, AZ (US)

(21) Appl. No.: 18/213,381

(22) Filed: Jun. 23, 2023

(51) Int. Cl. G06F 1/12; G06F 1/10

(52) U.S. Cl. CPC G06F 1/12; G06F 1/10

(57) ABSTRACT

An apparatus includes a clock monitoring circuit and a multiplexing circuit. The clock monitoring circuit includes an output terminal. The clock monitoring circuit is configured to generate a control signal based on monitoring a plurality of clock signals. The multiplexing circuit is coupled to the output terminal of the clock monitoring circuit and is configured to receive the control signal. The multiplexing circuit includes a first input terminal to receive a first signal generated based on a first clock signal of the plurality of clock signals. The multiplexing circuit includes a second input terminal to receive a second signal generated based on a second clock signal of the plurality of clock signals. The multiplexing circuit includes an output terminal to output one of the first signal or the second signal based on the control signal.

### TECHNICAL FIELD

Embodiments pertain to the rapid transfer of data operands between functional blocks of digital logic with different clock frequencies (e.g., where the clock signals have a deterministic relationship).

### BACKGROUND

Computer platforms and electronic systems frequently move data between separate functional units of digital blocks which are individually clocked. If this data movement is slow, there is a potential bottleneck, and system performance is negatively affected, impacting computers, smartphones, and a plethora of other devices.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 illustrates a block diagram of existing techniques for a continuous acknowledge loop used to generate strobed data between a transmitting component and a receiving component;

FIG. 2 illustrates a timing diagram for data transmission and reception using the continuous acknowledge loop of FIG. 1;

FIG. 3 illustrates a block diagram of a clock management circuit including a continuous acknowledge loop used to generate strobed data between a transmitting component and a receiving component using a clock monitoring circuit and a multiplexing circuit, in accordance with some embodiments;

FIG. 4 illustrates a timing diagram for data transmission and reception using the continuous acknowledge loop of FIG. 3, in accordance with some embodiments;

FIG. 5 is a flow diagram of an example method for communicating data between communication domains using different clock frequencies, in accordance with some embodiments; and

FIG. 6 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

As used herein, the term “chip” (or die) refers to a piece of a material, such as a semiconductor material, that includes a circuit such as an integrated circuit or a part of an integrated circuit. The term “memory IP” indicates memory intellectual property. The terms “memory IP,” “memory device,” “memory chip,” and “memory” are interchangeable.

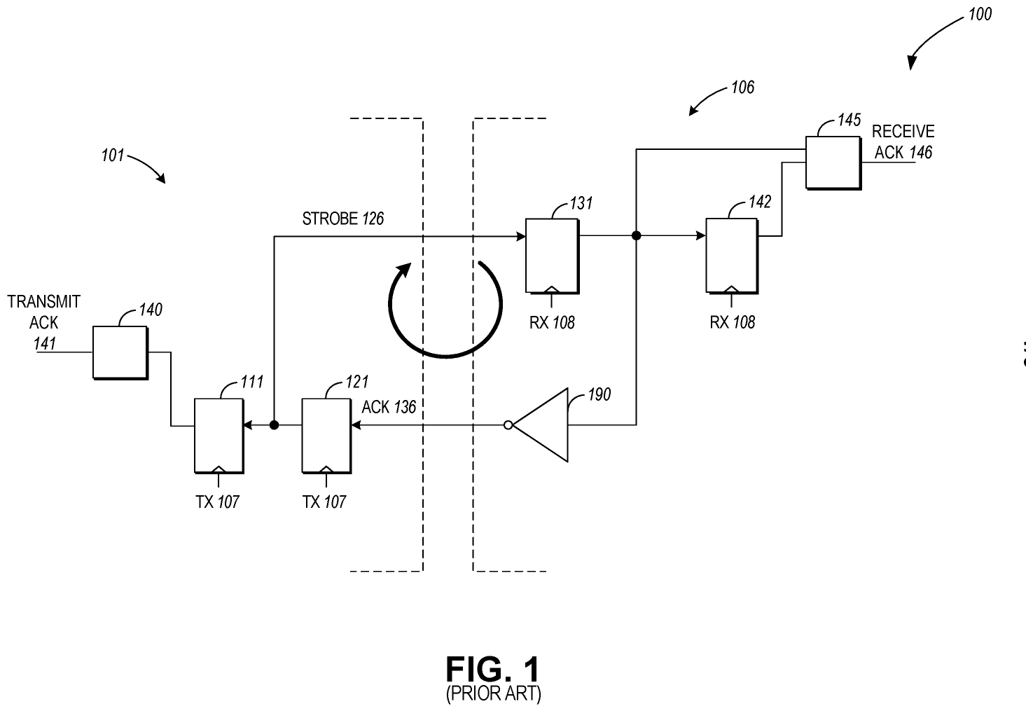

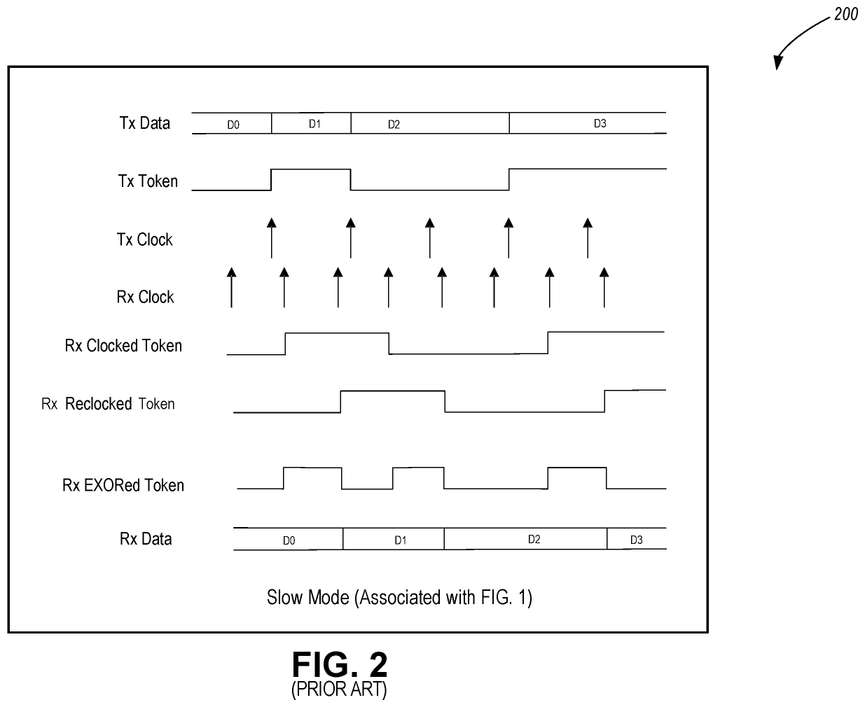

Many systems-on-a-chip (SoCs) and silicon systems transfer data operands synchronously between communication domains (e.g., a transmission domain associated with the transmission of data and a reception domain associated with the reception of data), where the clocks are of different frequencies. The prior art has addressed this with techniques to move data more quickly when the clocks of the functional units have a predictable, pseudo-synchronous (integer or fractional) relationship. For example, existing techniques (e.g., as disclosed by U.S. Pat. No. 6,067,629 issued to Murray, et al., hereafter referred to as “Murray”) use a token-passing mechanism to assist this transfer. The existing techniques associated with Murray are discussed in connection with FIG. 1 and FIG. 2.

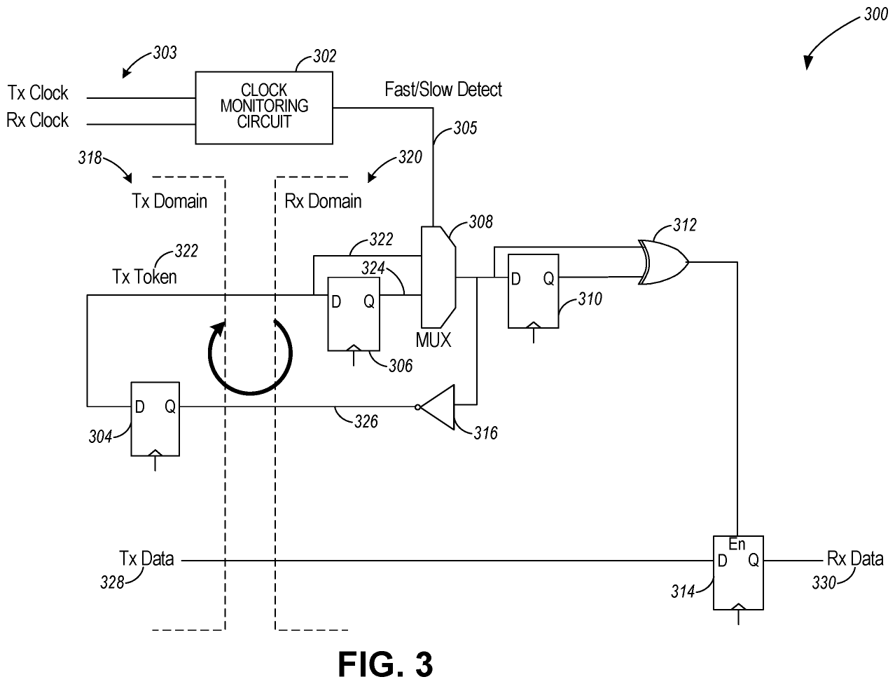

The disclosed techniques provide further improvement to Murray based on using a clock management circuit that includes a clock monitoring circuit and a multiplexing circuit. More specifically, the disclosed techniques (e.g., as discussed in connection with FIG. 3-FIG. 5) eliminate a register stage if the receiving domain's clock is faster than the transmitting domain's clock. This elimination allows data to be transferred at the rate of the transmitting domain, which maximizes the data rate at the maximum available rate. The disclosed techniques allow for a performance gain in many applications, including interfaces between physical layers (PHYs) and media access control layers (MACs), accelerators and fabrics, and other types of interfaces between communication domains associated with different clock frequencies.

Processing techniques previously disclosed by Murray are discussed in connection with FIGS. 1-2. The essence of Murray is that with pseudo-synchronous clocks (e.g., two clock signals that have an integer relationship to each other) metastability issues can be discounted when moving a token from one clock domain to another. This token can be used to indicate the validity of multi-bit data operands, allowing fast data transfer from one domain to another.

FIG. 1 illustrates a block diagram 100 of existing techniques for a continuous acknowledge loop used to generate strobed data between a transmitting component and a receiving component. Referring to FIG. 1, component 101 operates in a first communication domain (also referred to as a frequency domain or a clock domain) and transmits data to component 106 operating in a second frequency domain. Component 101 includes a logic block 140, and latches (also referred to as registers, register circuits, or flip-flops) 111 and 121 (clocked by clock signal Tx 107). Component 106 includes logic block 145 (generating ACK 146), latches 131 and 142 (clocked by clock signal Rx 108), and inverter 190.

Component 101 uses strobe 126 and acknowledgment (ACK) 136 to synchronize the transmission of data between component 101 and component 106. An acknowledge signal transition on line ACK 136 indicates that component 106 has received an acknowledge signal on the communication line with strobe 126. The transmitting component generates strobe 126 in conjunction with new data. The acknowledge signal transition on line ACK 136 indicates that component 106 has received new data from component 101. Logic block 140 detects the acknowledge signal transition on line ACK 136 and strobes new data for transmissions between components 101 and 106 via ACK 141. The continuous acknowledge loop used to generate the strobed data between component 101 and component 106 includes strobe 126, latch 131, inverter 190, line ACK 136, and latch 121.

FIG. 2 illustrates a timing diagram 200 for data transmission and reception using the continuous acknowledge loop of FIG. 1. Referring to FIG. 2, diagram 200 illustrates the transfer of a token together with associated data operands between clock domains as implemented in Murray (e.g., as illustrated in FIG. 1). As seen in FIG. 2, the receive clock is running faster than the transmit clock, and four data operands are transmitted in the diagram. Occasionally, it takes multiple Tx clocks to move one operand.

Since the issuance of the Murray patent, technology has advanced, and variable clock speeds are used in many designs, allowing reduced power consumption and less heat dissipation. In some aspects, when moving data from one clock domain to another, one technique (e.g., as used by Murray) is to pass a token back and forth between the two communication domains (e.g., Tx and Rx domains) to indicate the presence of new data and acceptance of that new data. In some aspects, this token is synchronized to the receiving domain. In many cases this is necessary, but there is a penalty in timing efficiency as a register stage is required at the receiver.

In some embodiments, the disclosed techniques include a clock management circuit with an intelligent clock monitoring circuit that monitors clock signals of the communication domains (e.g., the Rx and Tx clocks associated with the corresponding Rx and Tx domains) and decides to use a clocked or an unclocked path at the Rx side for the token. More specifically, if the Rx clock is faster than the Tx clock, an unclocked path is selected via a multiplexing circuit and is used at the Rx for the token. If the Rx clock is slower than the Tx clock, a clocked path is selected via the multiplexing circuit and is used for the token. In some aspects, integer clock ratios manage setup and hold time requirements without the need for metastable flops. An example embodiment using the clock management circuit is discussed in connection with FIGS. 3-5.

FIG. 3 illustrates a block diagram of a clock management circuit 300 including a continuous acknowledge loop used to generate strobed data between a transmitting component and a receiving component using a clock monitoring circuit and a multiplexing circuit, in accordance with some embodiments. Referring to FIG. 3, the clock management circuit 300 includes a clock monitoring circuit 302 and a multiplexing circuit 308. The clock management circuit 300 is configured in connection with a device that includes one or more circuits operating within a first communication domain (e.g., Tx domain 318) and one or more circuits operating in a second communication domain (e.g., Rx domain 320). As used herein, the term “domain” can refer to circuitry associated with a particular clock signal frequency. In this regard, Tx domain 318 can indicate Tx circuitry (e.g., one or more circuits coupled via one or more interfaces) associated with the same clock signal frequency. Similarly, Rx domain 320 can indicate Rx circuitry (e.g., one or more circuits coupled via one or more interfaces) associated with the same clock signal frequency.

The Tx domain 318 includes a register circuit 304 clocked by a clock signal of a first frequency. The Rx domain 320 includes register circuits 306, 310, and 314 clocked by a clock signal of a second frequency. The Rx domain 320 further includes multiplexing circuit 308, logic block 312, and inverter 316. Register circuit 314 is coupled to data terminals associated with Tx data 328 and Rx data 330. Register circuit 314 is coupled to the output of logic block 312. The multiplexing circuit 308 receives a first input from register circuit 304 and a second input from register circuit 306. Inverter 316 receives input from the output of the multiplexing circuit 308 and generates an output coupled to register circuit 304 in the Tx domain 318.

As seen in FIG. 3, register circuits 304, 306, and 310 correspond to latches 121, 131, and 142 of Murray as illustrated in FIG. 1. Additionally, logic block 312 and inverter 316 correspond to logic block 145 and inverter 190 of Murray as illustrated in FIG. 1.

In some aspects, the clock monitoring circuit 302 receives as input signals 303 the clock signals used by the available communication domains (e.g., the Tx clock signal used by devices in the Tx domain 318 and the Rx clock signal used by devices in the Rx domain 320). The clock monitoring circuit 302 can perform a comparison of the clock signals received as input signals 303 and generate a control signal 305 based on the comparison.

The control signal 305 can control the inputs of multiplexing circuit 308 and select between the Tx token 322 (generated by register circuit 304 at the Tx domain 318 while using the Tx clock signal) or a buffered signal 324 generated as output of register circuit 306 (generated by register circuit 306 using the Tx token 322 while being clocked by the Rx clock signal associated with the Rx domain 320). For example and as mentioned above, if the Rx clock is faster than the Tx clock, the unclocked path can be used at the Rx domain 320 for the token (e.g., control signal 305 enables the first input of multiplexing circuit 308 so that the Tx token 322 is used directly as received from the Tx domain 318 and is output by multiplexing circuit 308 to inverter 316 without buffering at the register circuit 306). If the Rx clock is slower than the Tx clock, the clocked path is used for the token (e.g., control signal 305 enables the second input of multiplexing circuit 308 so that buffered signal 324 is received by multiplexing circuit 308 and output to inverter 316). The inverter 316 generates an inverted signal 326 communicated to register circuit 304.

In some embodiments, the clock monitoring circuit 302 generates a control signal 305 and configures switching between the first or second input of the multiplexing circuit 308 when the clocks are quiescent. In some aspects, in-flight switching of the multiplexing circuit inputs can be used as well.

About FIG. 1 and the processing performed in Murray, the average time to transfer one operand, regardless of clock speeds (Ptx is the transmit clock period, Prx is the receive clock period) is T=Ptx+(0.5*Prx).

In comparison, the average time to transfer one operand using the disclosed techniques (e.g., as discussed in connection with FIGS. 3-5), with Prx>Ptx (faster Rx clock, so no Rx register stage) is T=Ptx. In this regard, the disclosed techniques are associated with the latency in waiting for the Rx clock to be eliminated.

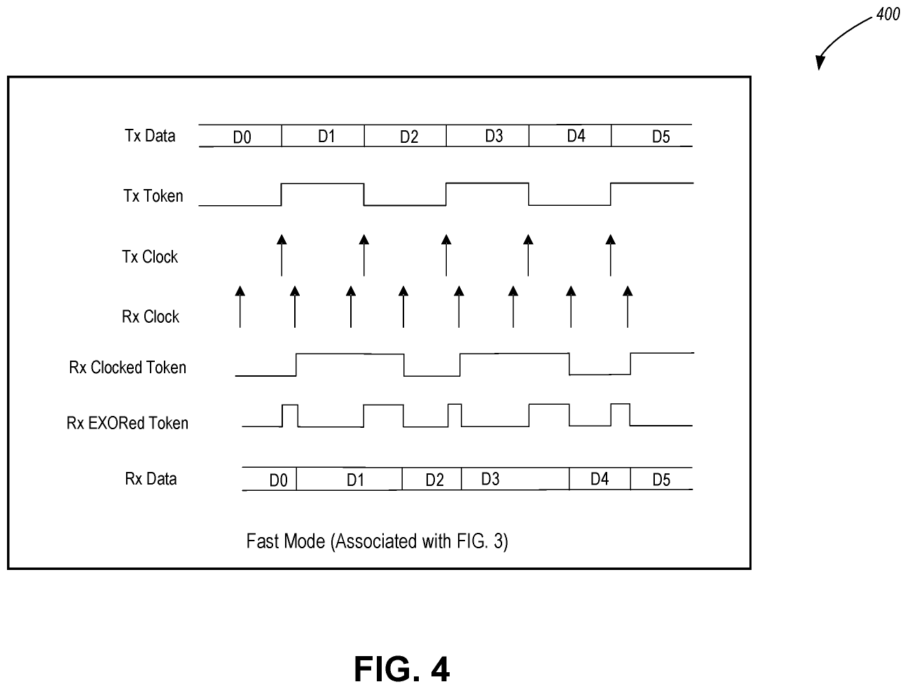

FIG. 4 illustrates a timing diagram 400 for data transmission and reception using the continuous acknowledge loop of FIG. 3, in accordance with some embodiments. Referring to FIG. 3 and FIG. 4, when the Rx domain 320 operates in fast mode (e.g., the Rx clock signal has a higher frequency than the Tx clock signal), register circuit 306 is bypassed and six operands can be transferred at the same time. As seen from timing diagram 400, one operand is moved for every Tx clock, which is the fastest possible transfer rate.

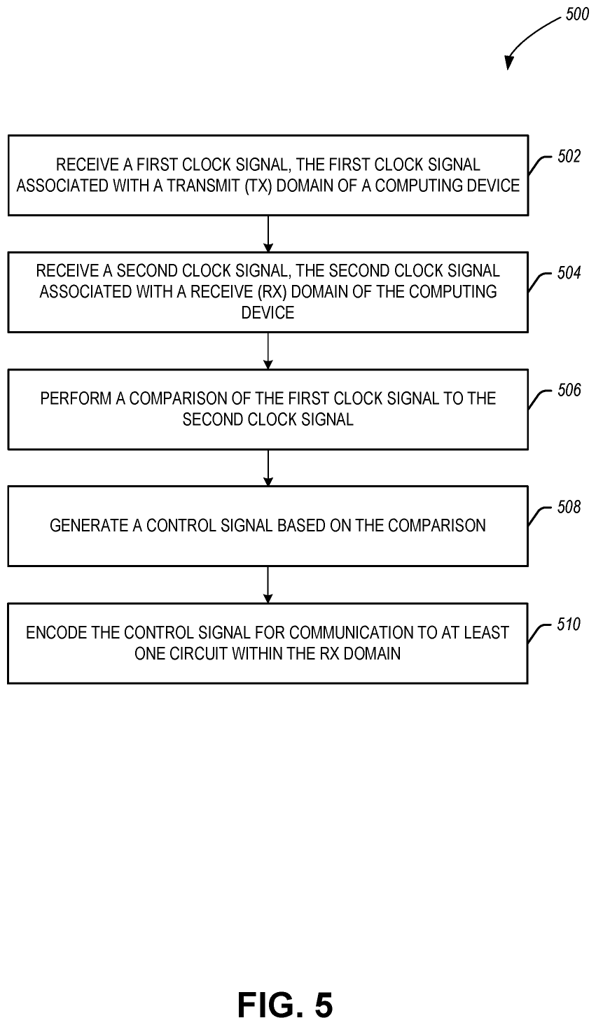

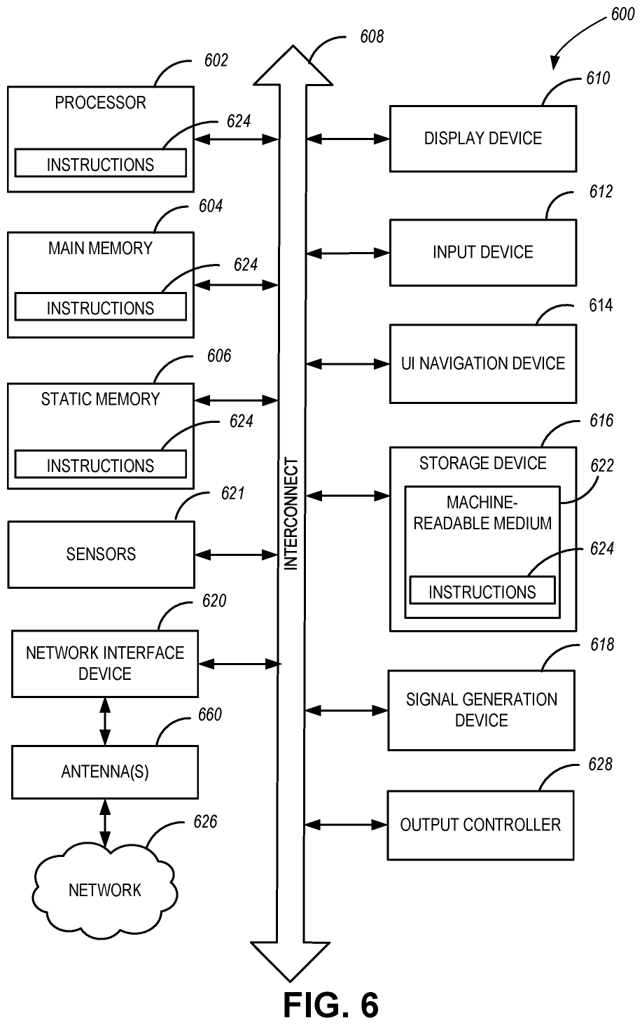

FIG. 5 is a flow diagram of an example method 500 for communicating data between communication domains using different clock frequencies, in accordance with some embodiments. Referring to FIG. 5, method 500 includes operations 502, 504, 506, 508, and 510, which may be executed by a clock management circuit or another processor of a computing device (e.g., hardware processor 602 of machine 600 illustrated in FIG. 6). In some embodiments, clock monitoring circuit 302 can perform the configuration and management functionalities discussed in FIG. 5 as well as in the examples listed below.

At operation 502, a first clock signal is received. For example, the first clock signal is Tx token 322 associated with Tx domain 318 of a computing device received at the Rx domain 320.

At operation 504, a second clock signal is received. For example, the second clock signal is a buffered signal (e.g., buffered signal 324) generated by register circuit 306 and is associated with the Rx domain 320 of the computing device. In some aspects, the first clock signal and the second clock signal are also communicated as input signals 303 to the clock monitoring circuit 302.

At operation 506, a comparison of the first clock signal to the second clock signal is performed (e.g., by the clock monitoring circuit 302).

At operation 508, a control signal is generated based on the comparison. For example, the clock monitoring circuit 302 generates a control signal 305 based on the comparison.

At operation 510, the control signal is encoded for communication to at least one circuit within the Rx domain. For example, control signal 305 is communicated to multiplexing circuit 308, where it is used for selecting one of Tx token 322 or the buffered signal 324 for further processing at the Rx domain 320.

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, machine 600 may operate in the capacity of a server machine, a client machine, or both in server-client network environments. In an example, machine 600 may function as a peer machine in a peer-to-peer (P2P) (or other distributed) network environment. The machine 600 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 600 may include a hardware processor 602 (e.g., a central processing unit (CPU), a graphics processing unit (GPU), a hardware processor core, or any combination thereof), a main memory 604, and a static memory 606, some or all of which may communicate with each other via an interlink (e.g., bus) 608. In some aspects, the main memory 604, the static memory 606, or any other type of memory (including cache memory) used by the machine 600 can be configured based on the disclosed techniques or can implement the disclosed memory devices.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 600 may further include a display device 610, an input device 612 (e.g., a keyboard), and a user interface (UI) navigation device 614 (e.g., a mouse). In an example, the display device 610, input device 612, and UI navigation device 614 may be a touch screen display. The machine 600 may additionally include a storage device (e.g., drive unit or another mass storage device) 616, a signal generation device 618 (e.g., a speaker), a network interface device 620, and one or more sensors 621, such as a global positioning system (GPS) sensor, compass, accelerometer, or other sensors. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 602 and/or instructions 624 may comprise processing circuitry and/or transceiver circuitry.

The storage device 616 may include a machine-readable medium 622 on which is stored one or more sets of data structures or instructions 624 (e.g., software) embodying or utilized by any one or more of the techniques or functions described herein. Instructions 624 may also reside, completely or at least partially, within the main memory 604, within static memory 606, or the hardware processor 602 during execution thereof by the machine 600. In an example, one or any combination of the hardware processor 602, the main memory 604, the static memory 606, or the storage device 616 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 622 is illustrated as a single medium, the term “machine-readable medium” may include a single medium or multiple media (e.g., a centralized or distributed database, and/or associated caches and servers) configured to store instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, one or more sensors 621, a network interface device 620, one or more antennas 660, a display device 610, an input device 612, a UI navigation device 614, a storage device 616, instructions 624, a signal generation device 618, and an output controller 628. The apparatus may be configured to perform one or more of the methods and/or operations disclosed herein. The apparatus may be intended as a component of machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 600 and that causes machine 600 to perform any one or more of the techniques of the present disclosure, or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 624 may further be transmitted or received over a communications network 626 using a transmission medium via the network interface device 620 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that can store, encode, or carry instructions for execution by the machine 600, and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments such as part of a system on chip, a set of intercommunicating functional blocks, or similar, although the scope of the disclosure is not limited in this respect.

Described implementations of the subject matter can include one or more features, alone or in combination as illustrated below by way of examples.

Example 1 is an apparatus comprising: a clock monitoring circuit comprising an output terminal, the clock monitoring circuit configured to generate a control signal based on monitoring a plurality of clock signals; and a multiplexing circuit coupled to the output terminal of the clock monitoring circuit and configured to receive the control signal, the multiplexing circuit comprising: a first input terminal to receive a first signal generated based on a first clock signal of the plurality of clock signals; a second input terminal to receive a second signal generated based on a second clock signal of the plurality of clock signals; and an output terminal to output one of the first signal or the second signal based on the control signal.

In Example 2, the subject matter of Example 1 includes a first register circuit comprising a data terminal and an output terminal, the output terminal of the first register circuit coupled to the second input terminal of the multiplexing circuit.

In Example 3, the subject matter of Example 2 includes subject matter where the first register circuit comprises a clock terminal configured to receive the second clock signal, and wherein the first register is clocked by the second clock signal.

In Example 4, the subject matter of Examples 2-3 includes subject matter where the data terminal of the first register circuit is coupled to an output terminal of a second register circuit.

In Example 5, the subject matter of Example 4 includes subject matter where the data terminal of the first register circuit receives the first signal from the output terminal of the second register circuit.

In Example 6, the subject matter of Examples 4-5 includes subject matter where the second register circuit comprises a clock terminal configured to receive the second clock signal, and wherein the second register circuit is clocked by the second clock signal.

In Example 7, the subject matter of Examples 2-6 includes subject matter where the first register circuit is configured to receive the first signal at the data terminal.

In Example 8, the subject matter of Example 7 includes subject matter where the first register circuit buffers the first signal to generate the second signal.

In Example 9, the subject matter of Examples 1-8 includes subject matter where the first signal is a transmit token generated based on the first clock signal.

In Example 10, the subject matter of Example 9 includes subject matter where the second signal is a buffered version of the transmit token, and the buffered version of the transmit token is generated based on the second clock signal.

In Example 11, the subject matter of Examples 1-10 includes subject matter where the clock monitoring circuit is to perform a comparison of the first clock signal to the second clock signal.

In Example 12, the subject matter of Example 11 includes subject matter where the clock monitoring circuit is to generate the control signal based on the comparison.

In Example 13, the subject matter of Example 12 includes subject matter where the multiplexing circuit is to output the first signal when the control signal indicates the second clock signal is faster than the first clock signal.

In Example 14, the subject matter of Examples 12-13 includes subject matter where the multiplexing circuit is to output the second signal when the control signal indicates the second clock signal is equal to or slower than the first clock signal.

In Example 15, the subject matter of Examples 1-14 includes, an inverter circuit coupled to the output terminal of the multiplexing circuit, the inverter circuit to generate an inverted signal based on the first signal or the second signal received from the multiplexing circuit.

In Example 16, the subject matter of Examples 9-15 includes subject matter where the transmit token is generated based on transferring data from transmit circuitry associated with the first clock signal to receive circuitry associated with the second clock signal.

In Example 17, the subject matter of Examples 1-16 includes subject matter where the apparatus comprises a processor, and wherein the processor includes the clock monitoring circuit and the multiplexing circuit.

In Example 18, the subject matter of Example 17 includes, one or more interconnects coupling the clock monitoring circuit and the multiplexing circuit.

Example 19 is a system comprising: memory; and at least one processor coupled to the memory, the at least one processor: receives a first clock signal, the first clock signal associated with a transmit (Tx) circuitry of a computing device; receives a second clock signal, the second clock signal associated with a receive (Rx) circuitry of the computing device; perform a comparison of the first clock signal to the second clock signal; generate a control signal based on the comparison; and encode the control signal for communication to at least one circuit within the Rx circuitry.

In Example 20, the subject matter of Example 19 includes, a first register circuit configured in the Tx circuitry, the first register circuit to generate a transmit token based on an inverted signal received from the Rx circuitry.

In Example 21, the subject matter of Example 20 includes subject matter where the first register circuit comprises a clock terminal to receive the first clock signal.

In Example 22, the subject matter of Examples 20-21 includes subject matter where the first register circuit generates the transmit token further based on the first clock signal.

In Example 23, the subject matter of Examples 20-22 includes, a second register circuit configured in the Rx circuitry, the second register circuit coupled to the first register circuit and configured to receive the transmit token.

In Example 24, the subject matter of Example 23 includes subject matter where the second register circuit comprises a clock terminal receiving the second clock signal.

In Example 25, the subject matter of Examples 23-24 includes subject matter where the second register circuit is configured to generate a buffered signal based on the second clock signal, the buffered signal corresponding to the transmit token.

In Example 26, the subject matter of Example 25 includes, a multiplexing circuit coupled to the at least one processor and the second register circuit.

In Example 27, the subject matter of Example 26 includes subject matter where the multiplexing circuit comprises a control terminal configured to receive the control signal.

In Example 28, the subject matter of Example 27 includes subject matter where the multiplexing circuit further comprises: a first input terminal to receive the transmit token; a second input terminal to receive the buffered signal; and an output terminal to output one of the transmit token or the buffered signal based on the control signal.

In Example 29, the subject matter of Example 28 includes subject matter where the multiplexing circuit is to output the transmit token when the control signal indicates the second clock signal is faster than the first clock signal.

In Example 30, the subject matter of Examples 28-29 includes subject matter where the multiplexing circuit is to output the buffered signal when the control signal indicates the second clock signal is equal to or slower than the first clock signal.

In Example 31, the subject matter of Examples 26-30 includes, an inverter circuit coupled to the multiplexing circuit within the Rx circuitry, the inverter circuit to generate an inverted signal based on the transmit token or the buffered signal received from the multiplexing circuit.

In Example 32, the subject matter of Examples 26-31 includes, one or more interfaces, wherein the at least one processor comprises the first register circuit, the second register circuit, and the multiplexing circuit, and wherein the first register circuit, the second register circuit, and the multiplexing circuit are communicatively coupled via the one or more interfaces.

Example 33 is a method comprising: receiving a first clock signal, the first clock signal associated with a transmit (Tx) circuitry of a computing device; receiving a second clock signal, the second clock signal associated with a receive (Rx) circuitry of the computing device; performing a comparison of the first clock signal to the second clock signal; generating a control signal based on the comparison; and encode the control signal for communication to at least one circuit within the Rx circuitry.

In Example 34, the subject matter of Example 33 includes, generating a transmit token based on an inverted signal received from the Rx circuitry and further based on the availability of data at the Tx circuitry.

In Example 35, the subject matter of Example 34 includes, generating the transmit token further based on the first clock signal.

In Example 36, the subject matter of Examples 34-35 includes, generating a buffered signal based on the second clock signal, the buffered signal corresponding to the transmit token.

In Example 37, the subject matter of Example 36 includes, multiplexing between the transmit token and the buffered signal based on the control signal.

In Example 38, the subject matter of Example 37 includes subject matter where the multiplexing comprises: outputting the transmit token to an inverter circuit when the control signal indicates the second clock signal is faster than the first clock signal.

In Example 39, the subject matter of Example 38 includes subject matter where the multiplexing comprises: outputting the buffered signal to the inverter circuit when the control signal indicates the second clock signal is equal to or slower than the first clock signal.

In Example 40, the subject matter of Examples 34-39 includes, transferring the data from the Tx circuitry to the Rx circuitry based on the generating of the transmit token.

Example 41 is at least one machine-readable medium including instructions that, when executed by processing circuitry, cause the processing circuitry to perform operations to implement any of Examples 1-40.

Example 42 is an apparatus comprising means to implement any of Examples 1-40.

Example 43 is a system to implement any of Examples 1-40.

Example 44 is a method to implement any of Examples 1-40.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a clock monitoring circuit comprising an output terminal, the clock monitoring circuit configured to generate a control signal based on monitoring a plurality of clock signals; and
a multiplexing circuit coupled to the output terminal of the clock monitoring circuit and configured to receive the control signal, the multiplexing circuit comprising:
a first input terminal to receive a first signal generated based on a first clock signal of the plurality of clock signals;
a second input terminal to receive a second signal generated based on a second clock signal of the plurality of clock signals; and
an output terminal to output one of the first signal or the second signal based on the control signal.

2. The apparatus of claim 1, further comprising:
a first register circuit comprising a data terminal and an output terminal, the output terminal of the first register circuit coupled to the second input terminal of the multiplexing circuit.

3. The apparatus of claim 2, wherein the first register circuit comprises a clock terminal configured to receive the second clock signal, and wherein the first register is clocked by the second clock signal.

4. The apparatus of claim 2, wherein the data terminal of the first register circuit is coupled to an output terminal of a second register circuit.

5. The apparatus of claim 4, wherein the data terminal of the first register circuit receives the first signal from the output terminal of the second register circuit.

6. The apparatus of claim 4, wherein the second register circuit comprises a clock terminal configured to receive the second clock signal, and wherein the second register circuit is clocked by the second clock signal.

7. The apparatus of claim 1, wherein the first signal is a transmit token generated based on the first clock signal.

8. The apparatus of claim 7, wherein the transmit token is generated based on transferring data from transmit circuitry associated with the first clock signal to receive circuitry associated with the second clock signal.

9. The apparatus of claim 1, wherein the apparatus comprises a processor, and wherein the processor includes the clock monitoring circuit and the multiplexing circuit.

10. The apparatus of claim 9, further comprising one or more interconnects coupling the clock monitoring circuit and the multiplexing circuit.

11. A system comprising:
memory; and
at least one processor coupled to the memory, the at least one processor to:
receive a first clock signal, the first clock signal associated with a transmit (Tx) circuitry of a computing device;
receive a second clock signal, the second clock signal associated with a receive (Rx) circuitry of the computing device;
perform a comparison of the first clock signal to the second clock signal;
generate a control signal based on the comparison; and
encode the control signal for communication to at least one circuit within the Rx circuitry.

12. The system of claim 11, further comprising:
a first register circuit configured in the Tx circuitry, the first register circuit to generate a transmit token based on an inverted signal received from the Rx circuitry.

13. The system of claim 12, further comprising:
a second register circuit configured in the Rx circuitry, the second register circuit coupled to the first register circuit and configured to receive the transmit token.

14. The system of claim 13, wherein the second register circuit comprises a clock terminal receiving the second clock signal.

15. The system of claim 13, wherein the second register circuit is configured to generate a buffered signal based on the second clock signal, the buffered signal corresponding to the transmit token.

16. The system of claim 15, further comprising:
a multiplexing circuit coupled to the at least one processor and the second register circuit.

17. The system of claim 16, further comprising one or more interfaces, wherein the at least one processor comprises the first register circuit, the second register circuit, and the multiplexing circuit, and wherein the first register circuit, the second register circuit, and the multiplexing circuit are communicatively coupled via the one or more interfaces.

18. A method comprising:
receiving a first clock signal, the first clock signal associated with a transmit (Tx) circuitry of a computing device;
receiving a second clock signal, the second clock signal associated with a receive (Rx) circuitry of the computing device;
performing a comparison of the first clock signal to the second clock signal;
generating a control signal based on the comparison; and
encode the control signal for communication to at least one circuit within the Rx circuitry.

19. The method of claim 18, further comprising:
generating a transmit token based on an inverted signal received from the Rx circuitry and further based on availability of data at the Tx circuitry.

20. The method of claim 19, further comprising:
transferring the data from the Tx circuitry to the Rx circuitry based on the generating of the transmit token.
